(19) United States
(12) Patent Application Publication
(10) Pub. No.: US 2025/0026179 A1
(43) Pub. Date: Jan. 23, 2025

(54) METHODS AND SYSTEMS FOR OPTIMIZING CLIMATE CONTROL WITHIN A CLIMATE CONTROLLED SPACE

(71) Applicant: THERMO KING LLC, Minneapolis, MN (US)

(72) Inventors: James E Conde, Plymouth, MN (US); Quinn Morrison, Minneapolis, MN (US); Matthew Stinson, Minneapolis, MN (US); Grant A. Baumgardner, Minneapolis, MN (US)

(21) Appl. No.: 18/356,603

(22) Filed: Jul. 21, 2023

(51) Int. Cl. B60H 1/32

(52) U.S. Cl. CPC B60H 1/3211; B60H 2001/3255; B60H 2001/3272

(57) ABSTRACT

A method of controlling a transport climate control system is disclosed. The method includes a controller instructing the transport climate control system to operate in a continuous mode in order to provide climate control within a climate controlled space. The method also includes the controller monitoring a temperature within the climate controlled space. Upon the temperature within the climate controlled space reaching a cycle-off temperature, the controller instructing the transport climate control system to operate in a start-stop mode. The method further includes the controller determining a reference duty cycle. Also, the method includes the controller scaling the reference duty cycle to obtain a scaled duty cycle based on the reference duty cycle and a predetermined efficient climate capacity of the transport climate control system. Moreover, the method includes the controller operating the transport climate control system in the start-stop mode according to the scaled duty cycle.

### FIELD

The embodiments disclosed herein relate generally to a transport climate control system (TCS). More particularly, the embodiments described herein relate to methods and systems for optimizing climate control within a climate controlled space conditioned by the TCS.

### BACKGROUND

A transport climate control system can include, for example, a transport climate control system (TCS) and/or a heating, ventilation and air conditioning (HVAC) system. A TCS is generally used to control an environmental condition (e.g., temperature, humidity, air quality, and the like) within a cargo space of a transport unit (e.g., a truck, a container (such as a container on a flat car, an intermodal container, etc.), a box car, a semi-tractor, a passenger vehicle, or other similar transport unit). The TCS can maintain environmental condition(s) of the cargo space to maintain cargo (e.g., produce, frozen foods, pharmaceuticals, etc.). In some embodiments, the transport unit can include a HVAC system to control a climate within a passenger space of the vehicle.

An auxiliary power unit (APU) can be used to provide power to a transport unit. APUs are commonly used with TCSs, such as tractors or trucks (e.g., semi-tractors), to provide power to a sleeper cabin for the occupant (e.g., driver or passenger) to rest during a journey when the primary power source (e.g., tractor prime mover, high voltage battery source, etc.) is turned off (e.g., deactivated). This can reduce overall electrical power or fuel consumption, maintenance costs, emissions, and noise generated by not requiring the tractor main power source to operate (e.g., idle when the main power source is a tractor prime mover) during occupant rest periods or other periods of vehicle non-movement.

### SUMMARY

The embodiments disclosed herein relate generally to a transport climate control system (TCS). More particularly, the embodiments described herein relate to methods and systems for optimizing climate control within a climate controlled space conditioned by the TCS.

The embodiments described herein can calculate a temperature trajectory within the climate controlled space and use the temperature trajectory as a temperature setpoint while the TCS is operating in a start-stop mode. A measured temperature error relative to the temperature trajectory can be used to modulate heating or cooling capacity of the TCS to reduce cycling frequency in the start-stop mode while allowing the temperature in the climate controlled space to reach a low temperature setpoint at which the variable speed compressor can be cycled off without wastefully producing excess heating or cooling capacity. Thus, the embodiments described herein can optimize the temperature control behavior of the TCS for improved efficiency, system health, and temperature control in the climate controlled space.

The embodiments described herein can ensure that the temperature in the climate controlled space reaches the desired cycle-off temperature setpoint (i.e., the temperature at which the variable speed compressor is turned off in the start-stop mode). This can prevent a steady state offset between the measured climate controlled space temperature and the cycle-off temperature setpoint by calculating the heating or cooling capacity request based on a deviation between the measured climate controlled space temperature and a calculated trajectory, thereby using an integrator to force the temperature error to zero.

Also, the embodiments described herein can utilize a variable speed compressor in which peak capacity and peak efficiency are not always at the same compressor speed. This can help ensure that the start-stop mode is operated more efficiently.

A variable speed compressor of the TCS can have a minimum capacity that can be produced efficiently. During certain operating periods in the start-stop mode, the TCS can be controlled to provide climate control at a most efficient capacity of the TCS. In an embodiment, the most efficient capacity of the TCS is when the TCS operate the variable speed compressor at the most efficiency capacity of the variable speed compressor.

It is appreciated that a combination of hardware constraints, setpoint, ambient conditions, and/or the like may prevent the TCS from operating at the most efficient capacity of the compressor. Hardware constraints can include a compressor minimum on time requirement and/or a minimum duration of an entire on/off compressor cycle. Such constraints are typically provided to support the reliability of the variable speed compressor. In an embodiment, the disclosed embodiments can be configured to provide climate control that meets the desired temperature setpoint requirement while operating the TCS efficiently by controlling the system capacity to satisfy one or more required minimum on times and/or one or more desired minimum on times of the variable speed compressor. For a non-limiting example, a compressor may have a required minimum on time of 5 minutes for receiving sufficient lubrication from the circulation of working fluid. The compressor may also have a desired minimum on time of 7 minutes for energy efficiency. Accordingly, a compressor on time of 7 minutes or more can satisfy the required minimum on time of 5 minutes and the desired minimum on time of 7 minutes.

For example, based on a cycle-on temperature (e.g., a high temperature setpoint while cooling) and a cycle-off temperature (e.g., a low temperature setpoint while cooling), the embodiments described herein can operate the TCS at a constant capacity, e.g., by operating the variable speed compressor of the TCS at a constant compressor speed. The compressor speed may be increased or decreased to meet a desired duty cycle or cycling frequency. The desired cycling frequency can also be modified to take into account hardware constraints such as a maximum cycling frequency for performance (e.g., lifespans, durability, or the like), for noise control, and/or for energy efficiency.

In some embodiments, a controller increases or decreases the capacity of the TCS to meet a compressor minimum on time requirement (e.g., for extending the lifespan and for increasing the durability of the variable speed compressor). In an embodiment, the controller can adjust the capacity of the TCS to avoid operating the TCS in a hot-gas bypass (HGB) mode. In a HGB mode, the climate control capacity demand may be less than a required minimum capacity of the compressor, below which the compressor is running below a minimum allowable compressor speed. The compressor can open a HGB line to direct a portion of the produced climate control capacity internally for: delivering a net climate control capacity lower than the required minimum capacity of the compressor, increasing energy consumption and decreasing compressor efficiency. By managing the temperature trajectory, or the climate control demand overtime, the controller can minimize the amount of time when the TCS is operating in the wasteful HGB mode to increase overall energy efficiency of the TCS.

In some embodiments, the controller operates the variable speed compressor at a predetermined speed for a predetermined amount of time. The controller increases or decreases a previously set cycle-on time to meet desired temperature bounds. In such embodiments, the controller can be configured to optimize for compressor durability (e.g., minimizing cycling frequency of the compressor) and/or temperature comfort within the climate controlled space (e.g., reducing temperature fluctuation within the temperature range between the cycle-on temperature and the cycle-off temperature).

In one embodiment, a method of controlling a transport climate control system is disclosed. The method includes a controller instructing the transport climate control system to operate in a continuous mode in order to provide climate control within a climate controlled space. The method also includes the controller monitoring a temperature within the climate controlled space. Upon the temperature within the climate controlled space reaching a cycle-off temperature, the controller instructing the transport climate control system to operate in a start-stop mode. The method further includes the controller determining a reference duty cycle. Also, the method includes the controller scaling the reference duty cycle to obtain a scaled duty cycle based on the reference duty cycle and a predetermined efficient climate capacity of the transport climate control system. Moreover, the method includes the controller operating the transport climate control system in the start-stop mode according to the scaled duty cycle.

In another embodiment a transport climate control system is provided that includes a controller. The controller is configured to control the transport climate control system. The controller is configured to: instruct the transport climate control system to operate in a continuous mode in order to provide climate control within a climate controlled space; monitor a temperature within the climate controlled space; upon the temperature within the climate controlled space reaching a cycle-off temperature, instruct the transport climate control system to operate in a start-stop mode; determine a reference duty cycle; scale the reference duty cycle to obtain a scaled duty cycle based on the reference duty cycle and a predetermined efficient climate capacity of the transport climate control system; and operate the transport climate control system in the start-stop mode according to the scaled duty cycle.

### BRIEF DESCRIPTION OF THE DRAWINGS

References are made to the accompanying drawings that form a part of this disclosure and which illustrate embodiments in which the systems and methods described in this specification can be practiced.

FIG. 1A illustrates a schematic view of a vehicle with an APU and a secondary HVAC system, according to one embodiment.

FIG. 1B illustrates a perspective view of a climate controlled transport unit with a transport climate control system that are towed by a vehicle, according to one embodiment.

FIG. 1C illustrates a perspective view of a straight truck including a transport climate control system, according to one embodiment.

FIG. 1D illustrates a side view of a van including a transport climate control system, according to one embodiment.

FIG. 2 illustrates a flow diagram of a method for optimizing climate control within a climate controlled space, according to one embodiment.

Like reference numbers represent like parts throughout.

### DETAILED DESCRIPTIONS

The embodiments disclosed herein relate generally to a transport climate control system (TCS). More particularly, the embodiments described herein relate to methods and systems for optimizing climate control within a climate controlled space conditioned by the TCS.

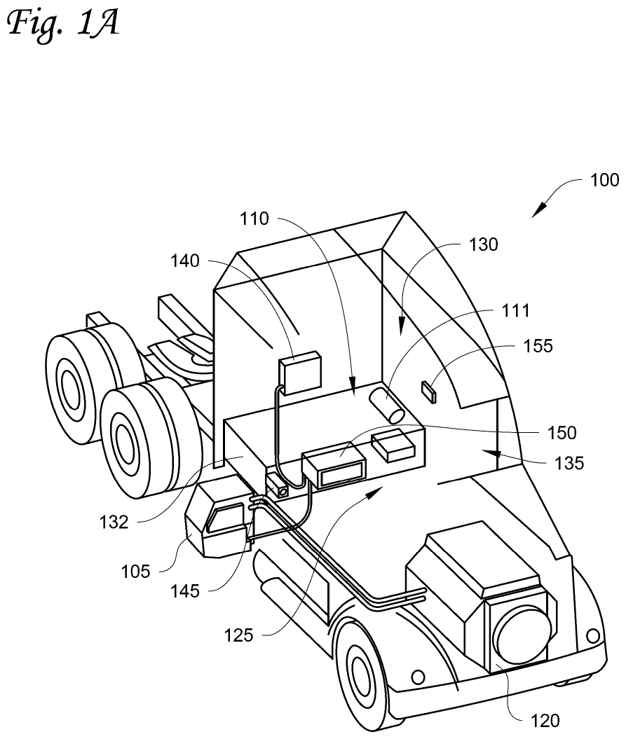

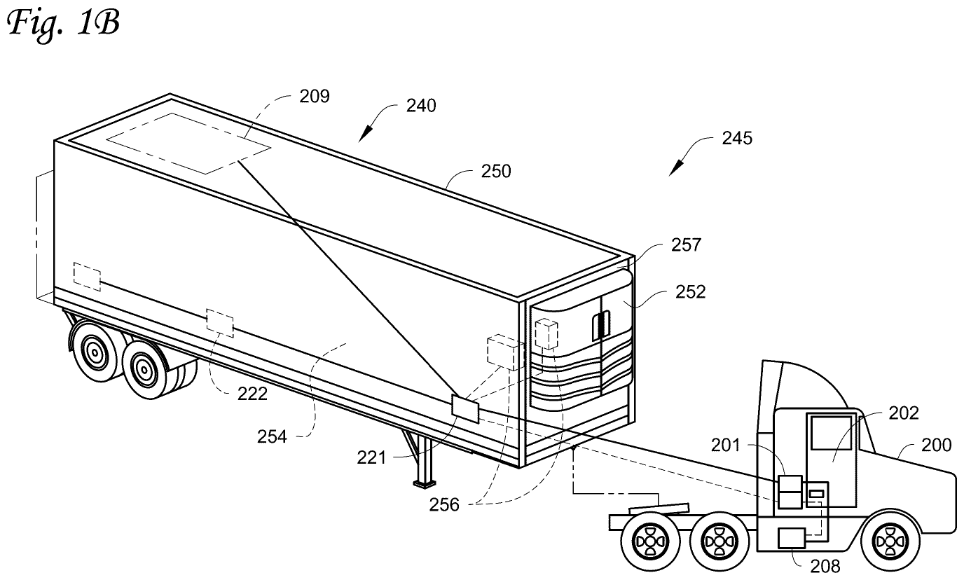

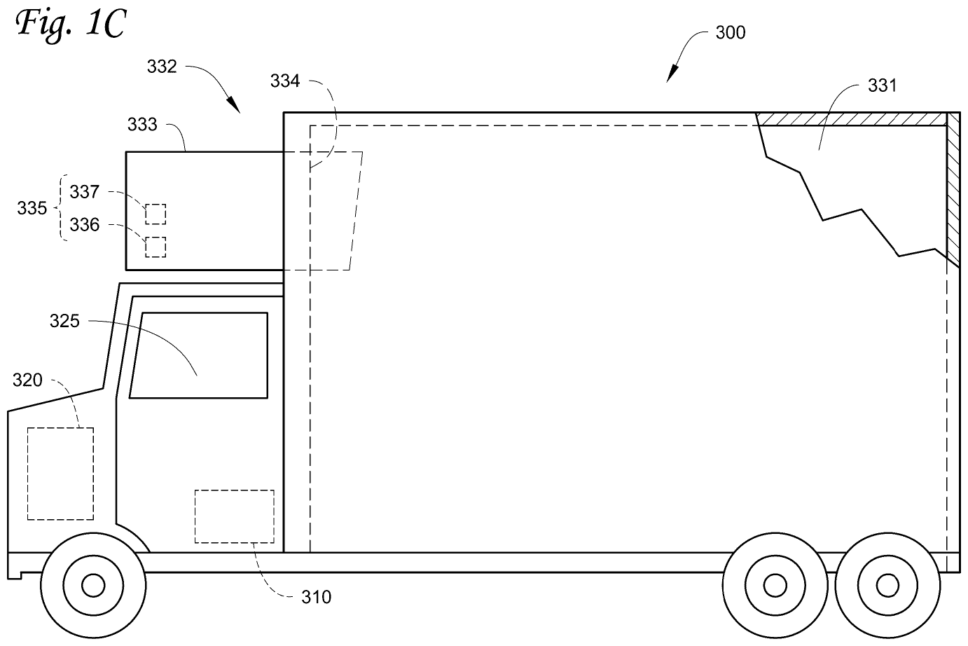

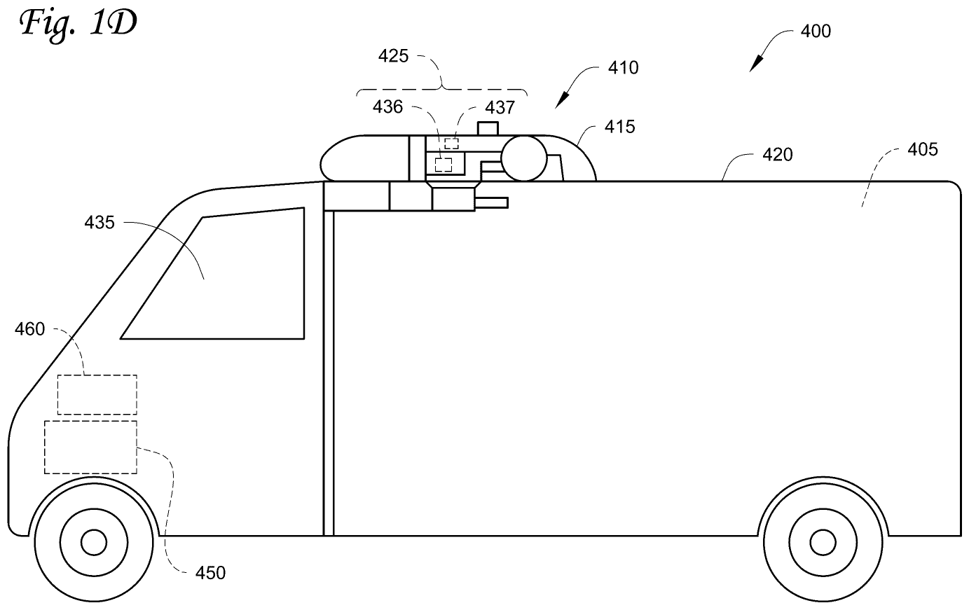

FIG. 1A illustrates a schematic view of a vehicle 100 with an APU 105 and a secondary HVAC system 110, according to some embodiments. The vehicle 100 is a semi-tractor (e.g., a class 8 tractor) that can be used, for example, to transport cargo stored in a cargo compartment (e.g., a container, a trailer, etc.) to one or more destinations. It will be appreciated that in other embodiments, the vehicle 100 can be, for example, a straight truck, a van, a passenger bus, etc. Hereinafter, the term “vehicle” shall be used to represent all such vans, tractors, trucks, buses, and the like, and shall not be construed to limit the invention's application solely to a tractor in a tractor-trailer combination. In some embodiments, the methods and systems can be configured to optimize climate control within any type of climate controlled space conditioned by a climate control system having a desired setpoint and a continuously or discretely variable capacity (including, for example, commercial and/or residential climate control applications). In some embodiments, the APU 105 can be a product (for example, a bolt-on APU) separate from the vehicle 100. In some embodiments, the APU 105 can be integrated in the vehicle power system design (for example, in an OEM-integrated bunk climate control system).

The vehicle 100 includes a primary power source 120, a cabin 125 defining a sleeping portion 130 and a driving portion 135, and a plurality of vehicle accessories (not shown). The cabin 125 can be accessible via a driver side door and/or a passenger side door (shown in FIG. 1B). The cabin 125 can include a primary HVAC system (not shown) as a vehicle accessory that can be configured to provide conditioned air within driving portion 135 and potentially the entire cabin 125. The secondary HVAC system 110 can be configured to provided conditioned air within the sleeping portion 130. The cabin 125 can also include a plurality of cabin accessories (e.g., secondary HVAC system 110). Examples of cabin accessories can include, for example, sunshade(s) for a window/windshield of the vehicle 100, a refrigerator, a television, a video game console, a microwave, one or more device charging station(s), a continuous positive airway pressure (CPAP) machine, and a coffee maker. In an embodiment, the secondary HVAC system 110 can be a cabin accessory.

The primary power source 120 can provide sufficient power to operate (e.g., drive) the vehicle 100 and any of a plurality of vehicle accessories (e.g., the primary HVAC system) and cabin accessories. In some embodiments, the primary power source 120 is the only power source that provides power to the primary HVAC system. The primary power source 120 can also provide power to charge, for example, batteries of the APU 105. In some embodiments, the primary power source 120 can be a prime mover such as, for example, a diesel engine. In some embodiments, the primary power source 120 can be an electric engine or a high-voltage electrical power unit. In some embodiments, the primary power source 120 can be a hybrid power source including, for example, a prime mover and an electric motor.

The APU 105 is a secondary power unit for the vehicle 100 when the primary power source 120 is unavailable. When, for example, the primary power source 120 is unavailable, the APU 105 can be configured to provide power to one or more of the vehicle accessories and the cabin accessories. In particular, the APU 105 can provide power to the secondary HVAC system 110 when the primary power source 120 (and accordingly the primary HVAC system) is unavailable. In some embodiments, the APU 105 can be an electric powered APU. In other embodiments, the APU 105 can be a prime mover powered APU. The APU 105 can be attached to the vehicle 100 using any attachment method. In some embodiments, the APU 105 can be turned on (i.e., activated) or off (i.e., deactivated) by an occupant (e.g., driver or passenger) of the vehicle 100. The APU 105 generally does not provide sufficient power for operating (e.g., driving) the vehicle 100.

In some embodiments, the APU 105 can include a power source (e.g., a prime mover, a battery, a fuel cell, etc.) for powering the APU 105, a working fluid (e.g., refrigerant) variable speed compressor 111 for the secondary HVAC system 110, an alternator (not shown), a maintenance switch (not shown), etc. In an embodiment, the working fluid variable speed compressor 111 can be a continuously variable compressor varying a compressor speed continuously within a predetermined range (e.g., between 100 and 1000 rpm). In another embodiment, the compressor 111 can be a compressor capable of operating in two or more discrete speeds (e.g., a two speed compressor, a three speed compressor, etc.).

The secondary HVAC system 110 includes a climate control circuit (not shown) that connects, for example, the variable speed compressor 111, a condenser, an evaporator and an expander to provide conditioned air within the sleeping portion 130. It is appreciated that an expander can be any suitable device for the working fluid within the climate control circuit, such as, for example, an expansion valve, one or more expansion orifices, or any suitable expansion device for use in a climate control circuit.

In addition, the secondary HVAC system 110 also includes a condenser unit 140 to house at least the condenser and one or more condenser fans, a heater unit 145, a configurable evaporator unit 150 to house at least the evaporator and one or more evaporator blower(s), and a controller 155. In some embodiments, the variable speed compressor 111 can be provided in the APU 105. In some embodiments, the variable speed compressor 111 can be provided in the configurable evaporator unit 150. In the embodiment shown in FIG. 1A, the condenser unit 140 is mounted at the back of the cabin 125 for condensing working fluid received from the compressor 111. The heater unit 145 is configured to provide heated air to the sleeping portion 130 and potentially the driving portion 135. In the embodiment shown in FIG. 1A, the heater unit 145 is positioned under a sleeping bunk 132 in the sleeping portion 130. The controller 155 can be a human machine interface (HMI) controller that controls operation of the secondary HVAC system 110 (including, for example, a power and operation mode of the secondary HVAC system 110, a temperature of conditioned air in the cabin 125, a fan speed of an evaporator blower of the configurable evaporator unit 150, etc.) and provides operation status information of the secondary HVAC system 110. In the embodiment shown in FIG. 1A, the controller 155 is positioned onto a wall of the vehicle 100 in the sleeping portion 130.

The configurable evaporator unit 150 is configured to provide conditioned air within the sleeping portion 130 and potentially the driving portion 135. In the embodiment shown in FIG. 1A, the configurable evaporator unit 150 is positioned under the sleeping bunk 132 in the sleeping portion 130. It will be appreciated that in other embodiments, the configurable evaporator unit 150 can be positioned in any other location within the vehicle 100 including, for example, on any side of the sleeping portion 130, within a cabinet (not shown) of the sleeping portion 130, within a closet (not shown) of the sleeping portion 130, etc. The configurable evaporator unit 150 can include one or more air outlet(s) from which one or more air duct(s) (not shown) can be connected to provide airflow to different locations within the vehicle 100.

In some embodiments, the controller 155 can control the secondary HVAC system 110 in a variety of operation modes. In some embodiments, the operating modes can, for example, include a continuous cooling mode, a start-stop cooling mode, a heating mode, a fan only mode, a null mode, and a defrost mode, etc. The secondary HVAC system 110 can operate in a continuous cooling mode when, for example, the secondary HVAC system 110 is attempting to cool the sleeping portion 130 as quickly as possible. In the continuous cooling mode, the variable speed compressor 111 is operated continuously. The secondary HVAC system 110 can operate in a start-stop cooling mode when, for example, the temperature in the climate controlled space is attempting to maintain or slowly adjust the climate in the sleeping portion 130 (e.g., the sleeping portion 130 has reached or is close to reaching a desired temperature setpoint). In the start-stop cooling mode, the variable speed compressor 111 is turned on for a set period of time and turned off for a second period of time. The secondary HVAC system 110 can operate in a heating mode when, for example, the secondary HVAC system 110 is attempting to heat the sleeping portion to a desired temperature setpoint. The secondary HVAC system 110 can operate in a fan only mode when, for example, the secondary HVAC system 110 is attempting to provide air flow within the sleeping portion 130 without heating or cooling the sleeping portion 130. The secondary HVAC system 110 can operate in a null mode when, for example, the variable speed compressor 111 is not operating and the fans may or may not be operating to provide airflow within the sleeping portion 130. The secondary HVAC system 110 can operate in a defrost mode when, for example, the secondary HVAC system 110 is attempting to defrost an evaporator coil of the climate control circuit.

FIG. 1B illustrates one embodiment of a climate controlled transport unit 240 attached to a vehicle 200. The climate controlled transport unit 240 includes a transport climate control system 245 for a transport unit 250. The vehicle 200 is attached to and is configured to tow the transport unit 250. The vehicle 200 (similar to the vehicle 100 shown in FIG. 1A) is a semi-tractor (e.g., a class 8 tractor) that can be used, for example, to transport cargo stored in a cargo compartment (e.g., a container, a trailer, etc.) to one or more destinations. The transport unit 250 shown in FIG. 1B is a trailer.

The transport climate control system 245 includes a climate control unit (CCU) 252 that provides environmental control (e.g. temperature, humidity, air quality, etc.) within a climate controlled space 254 of the transport unit 250. The CCU 252 is disposed on a front wall 257 of the transport unit 250. In other embodiments, it will be appreciated that the CCU 252 can be disposed, for example, on a rooftop or another wall of the transport unit 250. The CCU 252 includes a climate control circuit (not shown) that connects, for example, a variable speed compressor, a condenser, an evaporator and an expander to provide conditioned air within the climate controlled space 254. It is appreciated that an expander can be any suitable device for the working fluid within the climate control circuit, such as, for example, an expansion valve, one or more expansion orifices, or any suitable expansion device for use in a climate control circuit.

The transport climate control system 245 can operate in one or more operating modes including, for example, a continuous cooling mode, a start/stop cooling mode, a heating mode, a fan only mode, a null mode, and a defrost mode, and the like. The transport climate control system 245 can operate in the continuous cooling mode when, for example, the transport climate control system 245 is attempting to cool the climate controlled space 254 as quickly as possible (e.g, performing an initial pull down of the temperature in the climate controlled space 254 to a temperature setpoint, after the transport unit 240 has stopped to load or remove cargo from the climate controlled space 254, etc). The transport climate control system 245 can operate in a start/stop cooling mode when, for example, the temperature in the climate controlled space 254 is attempting to maintain or slowly adjust the climate in the climate controlled space 254 (e.g., the climate controlled space 254 has reached or is close to reaching a temperature setpoint. The transport climate control system 245 can operate in a heating mode when, for example, the transport climate control system 245 is attempting to heat the climate controlled space 254 to a temperature setpoint. The transport climate control system 245 can operate in a fan only mode when, for example, the transport climate control system 245 is attempting to provide air flow within the climate controlled space 254 without heating or cooling the climate controlled space 254. The transport climate control system 245 can operate in a null mode when, for example, the variable speed compressor is not operating and the fans may or may not be operating to provide airflow within the climate controlled space. The transport climate control system 245 can operate in a defrost mode when, for example, the transport climate control system 245 is attempting to defrost an evaporator coil of the climate control circuit.

The vehicle 200 includes an APU 208 and a primary HVAC system (not shown). In some embodiments, the APU 208 can be an electric auxiliary power unit (eAPU). Also, in some embodiments, the vehicle 200 can also include a vehicle power distribution unit 201 (PDU). The APU 208 can provide power to the vehicle PDU 201 for distribution. It will be appreciated that for the connections, solid lines represent power lines and dotted lines represent communication lines. The primary HVAC system is powered by the vehicle to provide climate control within the cabin 202.

The climate controlled transport unit 240 can include the PDU 221 connecting to power sources (including, for example, an optional solar power source 209; an optional power source 222 such as Genset, fuel cell, undermount power unit, auxiliary battery pack, etc.; and/or an optional liftgate battery, etc.) of the climate controlled transport unit 240. The PDU 221 can be configured to direct power from a power source to one or more load. The PDU 221 can include a PDU controller (not shown). The PDU controller can be a part of the climate controller 256. In an embodiment, the PDU 211 can be configured to power a secondary HVAC system (not shown) for conditioning a cabin 202 of the vehicle 200 when, for example, the primary HVAC system is not available.

The secondary HVAC system can include a climate control circuit (not shown) that connects, for example, a variable speed compressor, a condenser, an evaporator and an expander to provide conditioned air within the cabin 202.

In some embodiments, a controller can control the secondary HVAC system in a variety of operation modes. In some embodiments, the operating modes can, for example, include a continuous cooling mode, a start-stop cooling mode, a heating mode, a fan only mode, a null mode, and a defrost mode, etc. The secondary HVAC system can operate in a continuous cooling mode when, for example, the secondary HVAC system is attempting to cool the cabin 202 as quickly as possible. In the continuous cooling mode, the variable speed compressor is operated continuously. The secondary HVAC system can operate in a start-stop cooling mode when, for example, the temperature in the climate controlled space is attempting to maintain or slowly adjust the climate in the cabin 202 (e.g., the cabin 202 has reached or is close to reaching a desired temperature setpoint). In the start-stop cooling mode, the variable speed compressor is turned on for a set period of time and turned off for a second period of time. The secondary HVAC system can operate in a heating mode when, for example, the secondary HVAC system is attempting to heat the cabin 202 to a desired temperature setpoint. The secondary HVAC system can operate in a fan only mode when, for example, the secondary HVAC system is attempting to provide air flow within the cabin 202 without heating or cooling the cabin 202. The secondary HVAC system can operate in a null mode when, for example, the variable speed compressor is not operating and the fans may or may not be operating to provide airflow within the cabin 202. The secondary HVAC system can operate in a defrost mode when, for example, the secondary HVAC system is attempting to defrost an evaporator coil of the climate control circuit.

FIG. 1C illustrates a perspective view of a vehicle 300 including a transport climate control system 332, according to one embodiment. In an embodiment, the vehicle 300 can be a straight truck, a cargo truck, a climate-controlled truck, or the like. As shown in FIG. 1C, the vehicle 300 includes a climate controlled space 331 for carrying cargo and a transport climate control system 332. The transport climate control system 332 includes a CCU 333 that is mounted to a front wall 334 of the climate controlled space 331. The CCU 333 includes, amongst other components, a climate control circuit (not shown) that connects, for example, a variable speed compressor, a condenser, an evaporator and an expander to provide climate control within the climate controlled space 331.

The transport climate control system 332 also includes a programmable climate controller 335 and one or more sensors 336, 337 that are configured to measure one or more parameters of the transport climate control system 332 (e.g., an ambient temperature outside of the vehicle 300) an ambient humidity outside of the vehicle 300, a compressor suction pressure, a compressor discharge pressure, a supply air temperature of air supplied by the CCU 333 into the climate controlled space 331, a return air temperature of air returned from the climate controlled space 331 back to the CCU 333, a humidity within the climate controlled space 331, etc.) and communicate parameter data to the climate controller 335. The climate controller 335 is configured to control operation of the transport climate control system 332 including components of the climate control circuit.

The transport climate control system 332 can operate in one or more operating modes including, for example, a continuous cooling mode, a start/stop cooling mode, a heating mode, a fan only mode, a null mode, and a defrost mode, and the like. The transport climate control system 332 can operate in the continuous cooling mode when, for example, the transport climate control system 332 is attempting to cool the climate controlled space 331 as quickly as possible (e.g., performing an initial pull down of the temperature in the climate controlled space 331 to a temperature setpoint, after the vehicle 300 has stopped to load or remove cargo from the climate controlled space 331, etc.). The transport climate control system 332 can operate in a start/stop cooling mode when, for example, the temperature in the climate controlled space 331 is attempting to maintain or slowly adjust the climate in the climate controlled space 331 (e.g., the climate controlled space 331 has reached or is close to reaching a temperature setpoint. The transport climate control system 332 can operate in a heating mode when, for example, the transport climate control system 332 is attempting to heat the climate controlled space 331 to a temperature setpoint. The transport climate control system 332 can operate in a fan only mode when, for example, the transport climate control system 332 is attempting to provide air flow within the climate controlled space 331 without heating or cooling the climate controlled space 331. The transport climate control system 332 can operate in a null mode when, for example, the variable speed compressor is not operating and the fans may or may not be operating to provide airflow within the climate controlled space 331. The transport climate control system 332 can operate in a defrost mode when, for example, the transport climate control system 332 is attempting to defrost an evaporator coil of the climate control circuit.

The vehicle 300 includes a primary power source 320, a cabin 325 for carrying one or more users or operators of the vehicle 300, and a plurality of vehicle accessories (not shown). The cabin 325 can be conditioned by a primary HVAC system (not shown) as a vehicle accessory that is powered by the primary power source 320 and can be configured to provide conditioned air within the cabin 325. In an embodiment, the vehicle 300 can include a secondary HVAC system 310 for providing conditioned air within the cabin 325 when the primary HVAC system is not available (e.g., when the power source 320 is off or otherwise unavailable). The secondary HVAC system 310 can include a climate control circuit (not shown) that connects, for example, a variable speed compressor, a condenser, an evaporator and an expander to provide conditioned air within the cabin 325.

In some embodiments, a controller can control the secondary HVAC system in a variety of operation modes. In some embodiments, the operating modes can, for example, include a continuous cooling mode, a start-stop cooling mode, a heating mode, a fan only mode, a null mode, and a defrost mode, etc. The secondary HVAC system can operate in a continuous cooling mode when, for example, the secondary HVAC system is attempting to cool the cabin 325 as quickly as possible. In the continuous cooling mode, the variable speed compressor is operated continuously. The secondary HVAC system can operate in a start-stop cooling mode when, for example, the temperature in the climate controlled space is attempting to maintain or slowly adjust the climate in the cabin 325 (e.g., the cabin 325 has reached or is close to reaching a desired temperature setpoint). In the start-stop cooling mode, the variable speed compressor is turned on for a set period of time and turned off for a second period of time. The secondary HVAC system can operate in a heating mode when, for example, the secondary HVAC system is attempting to heat the cabin 325 to a desired temperature setpoint. The secondary HVAC system can operate in a fan only mode when, for example, the secondary HVAC system is attempting to provide air flow within the cabin 325 without heating or cooling the cabin 325. The secondary HVAC system can operate in a null mode when, for example, the variable speed compressor is not operating and the fans may or may not be operating to provide airflow within the cabin 325. The secondary HVAC system can operate in a defrost mode when, for example, the secondary HVAC system is attempting to defrost an evaporator coil of the climate control circuit.

FIG. 1D illustrates a side view of a vehicle 400 including a transport climate control system 410, according to one embodiment. As shown in FIG. 1D, the 400 is a climate controlled van. The vehicle 400 includes a climate controlled space 405 for carrying cargo and the transport climate control system 410 for providing climate control within the climate controlled space 405. The transport climate control system 410 includes a CCU 415 that is mounted to a rooftop 420 of the vehicle 400. The transport climate control system 410 can include, amongst other components, a climate control circuit (not shown) that connects, for example, a variable speed compressor, a condenser, an evaporator and an expander to provide climate control within the climate controlled space 405.

The transport climate control system 410 also includes a programmable climate controller 425 and one or more sensors 436, 437 that are configured to measure one or more parameters of the transport climate control system 410 (e.g., an ambient temperature outside of the vehicle 400, an ambient humidity outside of the vehicle 400, a compressor suction pressure, a compressor discharge pressure, a supply air temperature of air supplied by the CCU 415 into the climate controlled space 405, a return air temperature of air returned from the climate controlled space 405 back to the CCU 415, a humidity within the climate controlled space 405, etc.) and communicate parameter data to the climate controller 425. The climate controller 425 is configured to control operation of the transport climate control system 410 including the components of the climate control circuit.

The transport climate control system 410 can operate in one or more operating modes including, for example, a continuous cooling mode, a start/stop cooling mode, a heating mode, a fan only mode, a null mode, and a defrost mode, and the like. The transport climate control system 410 can operate in the continuous cooling mode when, for example, the transport climate control system 410 is attempting to cool the climate controlled space 405 as quickly as possible (e.g., performing an initial pull down of the temperature in the climate controlled space 405 to a temperature setpoint, after the vehicle 400 has stopped to load or remove cargo from the climate controlled space 405, etc.). The transport climate control system 410 can operate in a start/stop cooling mode when, for example, the temperature in the climate controlled space 405 is attempting to maintain or slowly adjust the climate in the climate controlled space 405 (e.g, the climate controlled space 405 has reached or is close to reaching a temperature setpoint. The transport climate control system 410 can operate in a heating mode when, for example, the transport climate control system 410 is attempting to heat the climate controlled space 405 to a temperature setpoint. The transport climate control system 410 can operate in a fan only mode when, for example, the transport climate control system 410 is attempting to provide air flow within the climate controlled space 405 without heating or cooling the climate controlled space 405. The transport climate control system 410 can operate in a null mode when, for example, the variable speed compressor is not operating and the fans may or may not be operating to provide airflow within the climate controlled space 405. The transport climate control system 410 can operate in a defrost mode when, for example, the transport climate control system 410 is attempting to defrost an evaporator coil of the climate control circuit.

The vehicle 400 includes a primary power source 450 for operating the vehicle 400, a cabin 435 for carrying one or more occupants within the vehicle 400, and a plurality of vehicle accessories (not shown). The cabin 435 can be conditioned by a primary HVAC system (not shown) that is powered by the primary power source 450. In an embodiment, the vehicle 400 can also include a secondary HVAC system 460 for providing conditioned air within the cabin 435 when, for example, the primary power source 450 is off or otherwise unavailable.

In some embodiments, a controller can control the secondary HVAC system in a variety of operation modes. In some embodiments, the operating modes can, for example, include a continuous cooling mode, a start-stop cooling mode, a heating mode, a fan only mode, a null mode, and a defrost mode, etc. The secondary HVAC system can operate in a continuous cooling mode when, for example, the secondary HVAC system is attempting to cool the cabin 435 as quickly as possible. In the continuous cooling mode, the variable speed compressor is operated continuously. The secondary HVAC system can operate in a start-stop cooling mode when, for example, the temperature in the climate controlled space is attempting to maintain or slowly adjust the climate in the cabin 435 (e.g., the cabin 435 has reached or is close to reaching a desired temperature setpoint). In the start-stop cooling mode, the variable speed compressor is turned on for a set period of time and turned off for a second period of time. The secondary HVAC system can operate in a heating mode when, for example, the secondary HVAC system is attempting to heat the cabin 435 to a desired temperature setpoint. The secondary HVAC system can operate in a fan only mode when, for example, the secondary HVAC system is attempting to provide air flow within the cabin 435 without heating or cooling the cabin 435. The secondary HVAC system can operate in a null mode when, for example, the variable speed compressor is not operating and the fans may or may not be operating to provide airflow within the cabin 435. The secondary HVAC system can operate in a defrost mode when, for example, the secondary HVAC system is attempting to defrost an evaporator coil of the climate control circuit.

It will be appreciated that the embodiments described herein are not limited to climate-controlled vans, but can apply to any type of transport unit (e.g., a truck, a container (such as a container on a flat car, an intermodal container, a marine container, etc.), a box car, a semi-tractor, a bus, or other similar transport unit), etc.

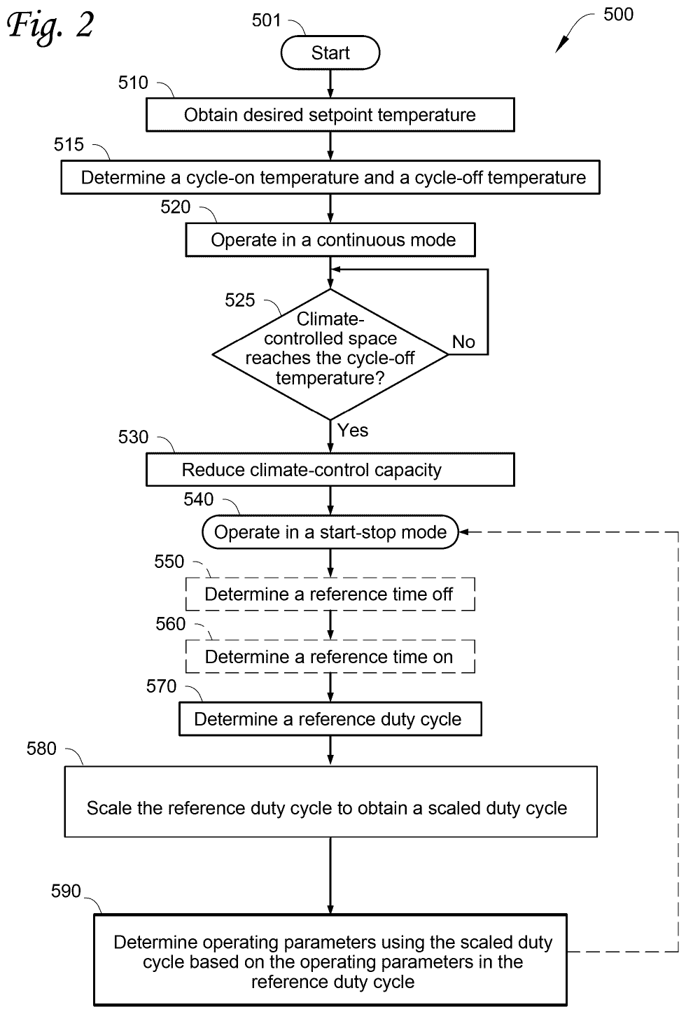

FIG. 2 illustrates a flow diagram of a method 500 for optimizing climate control within a climate controlled space, according to some embodiments. The method 500 can be operated with any type of transport climate control system (e.g., the transport climate control systems 245, 332, 410 and/or secondary HVAC systems 110 shown in FIGS. 1A-1D).

The method 500 begins at 501 whereby a controller (e.g., the controller 155, 256, 335, 425 of FIGS. 1A-D) starts the transport climate control system. The method 500 then proceeds to 510. At 510 the controller obtains a desired temperature setpoint for the climate controlled space. In some embodiments, the desired temperature setpoint can be input by an operator/occupant into a HMI of the controller. In some embodiments, the desired temperature setpoint can be received from an external source, for example, a remote server fleet manager, or the like.

In some embodiments, the method 500 is configured to provide climate control within the climate controlled space where the operator/occupant is located, such as a cabin of the vehicle (e.g., cabin 125, 202, 325, 435 of FIGS. 1A-D). In such embodiments, the desired temperature setpoint includes a temperature of which the operator/occupant prefers to have in the cabin. In other embodiments, the method 500 is configured to provide climate control within the climate controlled space where cargo is stored (e.g., climate controlled space 254, 331, 405 of FIGS. 1B-D). In such embodiments, the desired temperature setpoint can include a temperature required to maintain the cargo. Upon obtaining the desired setpoint temperature, the method 500 proceeds to 515.

At 515, the controller determines a cycle-on temperature and/or a cycle-off temperature. The cycle-on temperature can be a temperature threshold for the controller to instruct the variable speed compressor of the transport climate control system to compress working fluid flowing within a climate control circuit to provide climate control capacity (e.g., cooling capacity, heating capacity, etc.) within the climate controlled space. The cycle-off temperature can be a temperature can be a temperature threshold for the controller to instruct the variable speed compressor to stop compressing working fluid flowing within the climate control capacity to reduce or stop climate control capacity within the climate controlled space.

In a heating mode, the cycle-on temperature can be a lower temperature threshold determined by the controller based on the desired setpoint temperature. The cycle-off temperature can be an upper temperature threshold determined by the controller based on the desired setpoint temperature. In a cooling mode, the cycle-on temperature can be an upper temperature threshold determined by the controller based on the desired setpoint temperature. The cycle-off temperature can be a lower temperature threshold determined by the controller based on the desired setpoint temperature.

It is appreciated that the cycle-on/off temperature may be determined based on a predetermined offset from the desired temperature setpoint. For example, the desired temperature setpoint may be 72° F. and a predetermined offset of 3° F. above or 1° F. below. Accordingly, in a cooling mode, the cycle-on temperature can be 75° F. and the cycle-off temperature can be 71° F. In the embodiments disclosed herein, the cycle-on/off temperature may be updated during a continuous and/or start-stop mode of the transport climate control system to optimize the operation of the transport climate control system. Upon the determination of the cycle-on and/or the cycle-off temperature, the method 500 proceeds to 520.

At 520, the controller instructs the transport climate control system to operate in a continuous mode so that the temperature within the climate controlled space is conditioned to reach the cycle-off temperature from a previous temperature (e.g., an ambient temperature, a temperature of pervious setpoint temperature, or the like). In some embodiments, the transport climate control system can operate at a predetermined capacity during the continuous mode. The predetermined capacity can be a maximum capacity so that the temperature within the climate controlled space quickly reaches the cycle-off temperature. Then, the method 500 proceeds to 525.

At 525, the controller determines whether the climate controlled space has reached the cycle-off temperature. In some embodiments, one or more temperature sensors are disposed in the climate controlled space to monitor the temperature within the climate controlled space. Accordingly, the controller can compare the cycle-off temperature with the temperature within the climate controlled space measured by the one or more temperature sensors located in the climate controlled space. Upon the temperature within the climate controlled space reaching and/or exceeding the cycle-off temperature, the method 500 proceeds to 530.

At 530, the controller reduces the climate control capacity provided by the variable speed compressor. In some embodiments, the controller can instruct the variable speed compressor to stop compressing working fluid travelling through the climate control circuit. The method 500 then proceeds 540. It is appreciated that the controller may or may not immediately turn off the variable speed compressor once the temperature within the climate controlled space reaches the cycle-off or cycle-on temperature depending on other control requirements. The other control requirements can include, for example, the variable speed compressor compressing the working fluid for a minimum amount of time, a minimum cycling frequency of the variable speed compressor for noise control, or other control requirements that may delay the time at which the variable speed compressor is instructed to stop compressing working fluid. The method then proceeds to 540.

At 540, the controller instructs the transport climate control system to operate in a start-stop mode that cycles the variable speed compressor to start and stop compressing working fluid traveling within the climate control circuit in order to maintain the temperature within the climate controlled space around the desired temperature setpoint (e.g., in a temperature range between the cycle-off temperature and the cycle-on temperature).

It is appreciated that the start-stop mode includes a plurality of periods. A period can include a working portion and a resting portion. In some embodiments, the working portion includes the portion of a period in which the variable speed compressor compresses working fluid until the temperature within the climate controlled space reaches the cycle-off temperature. The resting portion includes the portion of a period in which the variable speed compressor compresses working fluid until the temperature within the climate controlled space reaches the cycle-on temperature. Then, the method 500 proceeds to 570, optionally through 550 and 560. At optional 550, the controller determines a reference time off which is an amount of time the transport climate control system takes to reach the cycle-off temperature. In some embodiments, the reference time off can be the amount of time required to complete the working portion of a period in the start-stop mode while the variable speed compressor is operating at a predetermined climate capacity. In some embodiments, the predetermined climate capacity can be a maximum capacity that can be provided by the transport climate control system. In such embodiments, the reference off time can be the shortest amount of time to complete the working portion of a period in start-stop mode. Then, the method 500 proceeds to 570, optionally through 560.

At optional 560, the controller determines a reference time on which is an amount of time the transport climate control system wait to reach the cycle-on temperature. In some embodiments, the reference time on can be the amount of time required to complete the resting portion of a cycle in the start-stop mode. Then, the method 500 proceeds to 570.

At 570, the controller determines a reference duty cycle for optimizing the transport climate control system in providing climate control. The reference duty cycle is the ratio of the amount of time of the working portion over the total time in the period (i.e., the sum of the time of the working portion and the time of the resting portion). In some embodiments, the reference duty cycle is determined based on the reference time off and reference time on obtained at 560 and 570. In an embodiment, the duty cycle may be calculated from a predetermined model (e.g., a simulation based model) based on ambient condition(s), desired climate setpoint(s), the capacity of the climate control system, and the like. In some embodiments, the determined or measured duty cycle may be used to update or calibrate and/or improve the predetermined model. Then, the method 500 proceeds to 580.

At 580, the controller scales the reference duty cycle determined at 570 to obtain a scaled duty cycle for operating the transport climate control system in the following period. It is appreciated that the predetermined climate capacity used to determine the reference cycle at 540-570 may or may not be the most efficient climate capacity for the variable speed compressor to operate. Generally, the efficient climate capacity can be a climate capacity lower than the maximum capacity and higher than a minimum capacity of the system. In an embodiment, energy efficiency can be characterized by its coefficient of performance that measures the ratio between energy consumption and the amount of heat transfer.

In an embodiment, the controller scales the reference duty cycle based on the efficient capacity relative to the predetermined capacity used to obtain the reference duty cycle. The controller can determine an amount of heat transfer based on the total amount of heat transfer in the reference cycle. In such an embodiment, the controller can calculate the total amount of heat transfer to be provided in the reference cycle, and determine the scaled duty cycle required to provide the same amount of heat transfer using the efficient climate capacity. For example, when the efficient capacity is 50% of the maximum capacity, the reference duty cycle (i.e.: reference on time: reference off time) is 1:1 at maximum capacity with a reference on time of 5 minutes. The scaled duty cycle for providing the same amount of heat transfer may be 2:1. In an embodiment, the amount of heat transfer may be scaled according to a change in ambient condition, operating condition of the transport climate control system, or the like. The scaling may be determined based on a first order differential model for heat transfer in the climate controlled space.

In an embodiment, the controller scales the reference duty cycle based on a maximum cycling frequency for performance and/or for noise control. Generally, the controller can instruct the variable speed compressor to compress working fluid and to not compress working fluid by changing one or more operations of the TCS equipment, such as the variable speed compressor. The variable speed compressor can be required to cycle on and cycle off less than a maximum frequency to support and maintain the designed performance of the variable speed compressor. The designed performance may be a reliability threshold, a predetermined power or climate capacity output threshold, an efficiency threshold, a durability or lifespan threshold, or the like. In an embodiment, the maximum cycling frequency may be characterized as a maximum number of switching instances per hour (e.g., starting 12 times an hour). In an embodiment, the maximum cycling frequency may be characterized as a minimum run time, such as, a minimum compressor run time of 5 minutes.

Frequently cycling on and off the transport climate control system can be less desirable for the operator/occupant than a less frequent cycling on and off the transport climate control system as it may lead to a more constant noise level. For example, the operator/occupant may be acclimated to a constant noise generated by equipment of the transport climate control system, such as the variable speed compressor. The sudden changes of noise (e.g., from no noise when the variable speed compressor is not compressing working fluid to an operating noise when variable speed compressor is compressing working fluid) may be more disruptive and irritating to the operator/occupant than a more constant noise level. In an embodiment, the maximum cycling frequency may be characterized as a maximum cycle of having the variable speed compressor compress working fluid and not compress working fluid, such as, a maximum number of switching instances per hour (e.g., starts 12 times an hour).

In some embodiments, the controller can construct a predictive model of a temperature trajectory of the temperature within the climate controlled space that can be used to determine the scaled duty cycle based on the reference duty cycle. The predictive model can be a first order differential model of heat transfer constructed from the reference duty cycle (e.g., including the reference cycle-on time and reference cycle-off time), a predetermined climate capacity (e.g., a maximum capacity), a cycle-on temperature, and a cycle-off temperature. Using the same cycle-on temperature, the cycle-off temperature, and an efficient climate control capacity, the controller may determine a calculated scaled duty cycle based on the constructed model. In an embodiment, the reference duty cycle can be determined using the maximum climate control capacity of the climate control system. In an embodiment, the calculated scaled duty cycle may be adjusted (e.g., lowered) if it exceeds the maximum cycling frequency. The climate control capacity may be lowered so that the temperature in the climate controlled space stays at or near the desired setpoint temperature. Then, the method 500 proceeds to 590.

At 590, the controller determines operating parameters for the transport climate control system using the scaled duty cycle that is based on the operating parameters in the reference duty cycle. In an embodiment, the operating parameters can include compressor-on time (e.g., the amount of time the compressor is compressing working fluid in a period), compressor-off time (e.g., the amount of time the compressor is not compressing working fluid in the period), climate control capacity, etc. Then, the method 500 may end and continue to use the same operating parameters to operate the climate controlled system, or optionally return to 540 whereby the scaled duty cycle now becomes the reference duty cycle.

### Aspects:

It is appreciated that any one of claims 1-10 can be combined.

Aspect 1. A method of controlling a transport climate control system, comprising:
a controller instructing the transport climate control system to operate in a continuous mode in order to provide climate control within a climate controlled space;
the controller monitoring a temperature within the climate controlled space;
upon the temperature within the climate controlled space reaching a cycle-off temperature, the controller instructing the transport climate control system to operate in a start-stop mode;
the controller determining a reference duty cycle;
the controller scaling the reference duty cycle to obtain a scaled duty cycle based on the reference duty cycle and a predetermined efficient climate capacity of the transport climate control system; and
the controller operating the transport climate control system in the start-stop mode according to the scaled duty cycle.
   Aspect 2. The method of aspect 1, wherein determining the reference duty cycle includes determining a reference cycle-on time and determining a reference cycle-off time.
   Aspect 3. The method of any one of aspects 1 and 2, further comprising, before determining the reference cycle-off time, the controller operating the transport climate control system to the cycle-off temperature at a maximum climate capacity.
   Aspect 4. The method of any one of aspects 1-3, further comprising:
upon the temperature within the climate controlled space reaching the cycle-off temperature, the controller:
   instructing a variable speed compressor of the transport climate control system to stop compressing working fluid, and
   determining the reference cycle-off time based on an amount of time for the transport climate control system to reach a cycle-on temperature from the cycle-off temperature while the variable speed compressor has stopped compressing working fluid; and
upon the temperature within the climate controlled space reaching the cycle-on temperature, the controller:
   instructing the variable speed compressor to compress working fluid,
   operating the transport climate control system at a maximum climate capacity, and determining a reference cycle-on time based on an amount of time for the transport climate control system to reach the cycle-off temperature from the cycle-on temperature while the variable speed compressor is compressing working fluid and the transport climate control system operating at the maximum climate capacity.
      Aspect 5. The method of any one of aspects 1-4, further comprising the controller determining at least one of a scaled cycle-on time, a scaled cycle-off time, and a scaled capacity based on the scaled duty cycle.
      Aspect 6. The method of any one of aspects 1-5, further comprising the controller determining a temperature trajectory of the scaled duty cycle and determining a scaled cycle on-time, a scaled cycle-off time, and a scaled climate capacity to minimize a temperature difference between the cycle-off temperature and a desired temperature setpoint within the climate controlled space.
      Aspect 7. The method of aspect 6, further comprising:
the controller operating the transport climate control system to reach a cycle-on temperature and the cycle-off temperature based on the scaled duty cycle; and
the controller updating the scaled cycle on-time and the scaled cycle-off time based on the updated scaled duty cycle for a following cycle of the controller operating the transport climate control system from the cycle-on temperature to the cycle-off temperature.
   Aspect 8. The method of any one of aspects 1-7, further comprising the controller determining the scaled duty cycle to be less than a maximum lifespan cycling frequency predetermined for prolonging a lifespan of the transport climate control system.
   Aspect 9. The method of any one of aspects 1-8, further comprising the controller determining the scaled duty cycle to be less than a maximum noise cycling frequency predetermined for controlling noise in the transport climate control system.
   Aspect 10. The method of any one of aspects 1-9, further comprising the controller determining the cycle-off temperature and a cycle-on temperature based on one or more predetermined offset temperatures from a desired temperature setpoint within the climate controlled space.
   Aspect 11. A transport climate control system comprising:
a controller configured to control the transport climate control system, wherein the controller is configured to:
instruct the transport climate control system to operate in a continuous mode in order to provide climate control within a climate controlled space;
monitor a temperature within the climate controlled space;
upon the temperature within the climate controlled space reaching a cycle-off temperature, instruct the transport climate control system to operate in a start-stop mode;
determine a reference duty cycle;
scale the reference duty cycle to obtain a scaled duty cycle based on the reference duty cycle and a predetermined efficient climate capacity of the transport climate control system; and
operate the transport climate control system in the start-stop mode according to the scaled duty cycle.
   Aspect 12. The transport climate control system of aspect 11, wherein the controller is further configured to determine a reference cycle-on time and determining a reference cycle-off time.
   Aspect 13. The transport climate control system of aspect 12, wherein the controller is further configured to operate the transport climate control system to the cycle-off temperature at a maximum climate capacity.
   Aspect 14. The transport climate control system of any one of aspects 11-13, wherein the controller is further configured to, upon the temperature within the climate controlled space reaching the cycle-off temperature, instruct a variable speed compressor of the transport climate control system to stop compressing working fluid, and
determine the reference cycle-off time based on an amount of time for the transport climate control system to reach a cycle-on temperature from the cycle-off temperature while the variable speed compressor has stopped compressing working fluid; and
upon the temperature within the climate controlled space reaching the cycle-on temperature, the controller is configured to:
   instruct the variable speed compressor to compress working fluid,
   operate the transport climate control system at a maximum climate capacity, and
   determine a reference cycle-on time based on an amount of time for the transport climate control system to reach the cycle-off temperature from the cycle-on temperature while the variable speed compressor is compressing working fluid and the transport climate control system operating at the maximum climate capacity.
      Aspect 15. The transport climate control system of any one of aspects 11-14, wherein the controller is further configured to determine at least one of a scaled cycle-on time, a scaled cycle-off time, and a scaled capacity based on the scaled duty cycle.
      Aspect 16. The transport climate control system of any one of aspects 11-15, wherein the controller is further configured to determine a temperature trajectory of the scaled duty cycle and determine a scaled cycle on-time, a scaled cycle-off time, and a scaled climate capacity to minimize a temperature difference between the cycle-off temperature and a desired temperature setpoint within the climate controlled space.
      Aspect 17. The transport climate control system of aspect 16, wherein the controller is further configured to:
operate the transport climate control system to reach a cycle-on temperature and the cycle-off temperature based on the scaled duty cycle; and
update the scaled cycle on-time and the scaled cycle-off time based on the updated scaled duty cycle for a following cycle of the controller operating the transport climate control system from the cycle-on temperature to the cycle-off temperature.
   Aspect 18. The transport climate control system of any one of aspects 11-17, wherein the controller is further configured to determine the scaled duty cycle to be less than a maximum lifespan cycling frequency predetermined for prolonging a lifespan of the transport climate control system.
   Aspect 19. The transport climate control system of any one of aspects 11-18, wherein the controller is further configured to determine the scaled duty cycle to be less than a maximum noise cycling frequency predetermined for controlling noise in the transport climate control system.
   Aspect 20. The transport climate control system of any one of aspects 11-19, wherein the controller is further configured to determine the cycle-off temperature and a cycle-on temperature based on one or more predetermined offset temperatures from a desired temperature setpoint within the climate controlled space.

The terminology used in this specification is intended to describe particular embodiments and is not intended to be limiting. The terms “a,” “an,” and “the” include the plural forms as well, unless clearly indicated otherwise. The terms “comprises” and/or “comprising,” when used in this specification, indicate the presence of the stated features, integers, steps, operations, elements, and/or components, but do not preclude the presence or addition of one or more other features, integers, steps, operations, elements, and/or components.

With regard to the preceding description, it is to be understood that changes may be made in detail, especially in matters of the construction materials employed and the shape, size, and arrangement of parts, without departing from the scope of the present disclosure. The word “embodiment” as used within this specification may, but does not necessarily, refer to the same embodiment. This specification and the embodiments described are examples only. Other and further embodiments may be devised without departing from the basic scope thereof, with the true scope and spirit of the disclosure being indicated by the claims that follow.

What is claimed is:

1. A method of controlling a transport climate control system, comprising:
a controller instructing the transport climate control system to operate in a continuous mode in order to provide climate control within a climate controlled space;
the controller monitoring a temperature within the climate controlled space;
upon the temperature within the climate controlled space reaching a cycle-off temperature, the controller instructing the transport climate control system to operate in a start-stop mode;
the controller determining a reference duty cycle;
the controller scaling the reference duty cycle to obtain a scaled duty cycle based on the reference duty cycle and a predetermined efficient climate capacity of the transport climate control system; and
the controller operating the transport climate control system in the start-stop mode according to the scaled duty cycle.

2. The method of claim 1, wherein determining the reference duty cycle includes determining a reference cycle-on time and determining a reference cycle-off time.

3. The method of claim 2, further comprising, before determining the reference cycle-off time, the controller operating the transport climate control system to the cycle-off temperature at a maximum climate capacity.

4. The method of claim 1, further comprising:
upon the temperature within the climate controlled space reaching the cycle-off temperature, the controller:
instructing a variable speed compressor of the transport climate control system to stop compressing working fluid, and
determining a reference cycle-off time based on an amount of time for the transport climate control system to reach a cycle-on temperature from the cycle-off temperature while the variable speed compressor has stopped compressing working fluid; and
upon the temperature within the climate controlled space reaching the cycle-on temperature, the controller:
instructing the variable speed compressor to compress working fluid,
operating the transport climate control system at a maximum climate capacity, and
determining a reference cycle-on time based on an amount of time for the transport climate control system to reach the cycle-off temperature from the cycle-on temperature while the variable speed compressor is compressing working fluid and the transport climate control system operating at the maximum climate capacity.

5. The method of claim 1, further comprising the controller determining at least one of a scaled cycle-on time, a scaled cycle-off time, and a scaled capacity based on the scaled duty cycle.

6. The method of claim 1, further comprising the controller determining a temperature trajectory of the scaled duty cycle and determining a scaled cycle on-time, a scaled cycle-off time, and a scaled climate capacity to minimize a temperature difference between the cycle-off temperature and a desired temperature setpoint within the climate controlled space.

7. The method of claim 6, further comprising:
the controller operating the transport climate control system to reach a cycle-on temperature and the cycle-off temperature based on the scaled duty cycle; and
the controller updating the scaled cycle on-time and the scaled cycle-off time based on the updated scaled duty cycle for a following cycle of the controller operating the transport climate control system from the cycle-on temperature to the cycle-off temperature.

8. The method of claim 1, further comprising the controller determining the scaled duty cycle to be less than a maximum lifespan cycling frequency predetermined for prolonging a lifespan of the transport climate control system.

9. The method of claim 1, further comprising the controller determining the scaled duty cycle to be less than a maximum noise cycling frequency predetermined for controlling noise in the transport climate control system.

10. The method of claim 1, further comprising the controller determining the cycle-off temperature and a cycle-on temperature based on one or more predetermined offset temperatures from a desired temperature setpoint within the climate controlled space.

11. A transport climate control system comprising:
a controller configured to control the transport climate control system, wherein the controller is configured to:
instruct the transport climate control system to operate in a continuous mode in order to provide climate control within a climate controlled space;
monitor a temperature within the climate controlled space;
upon the temperature within the climate controlled space reaching a cycle-off temperature, instruct the transport climate control system to operate in a start-stop mode;
determine a reference duty cycle;
scale the reference duty cycle to obtain a scaled duty cycle based on the reference duty cycle and a predetermined efficient climate capacity of the transport climate control system; and
operate the transport climate control system in the start-stop mode according to the scaled duty cycle.

12. The transport climate control system of claim 11, wherein the controller is further configured to determine a reference cycle-on time and determining a reference cycle-off time.

13. The transport climate control system of claim 12, wherein the controller is further configured to operate the transport climate control system to the cycle-off temperature at a maximum climate capacity.

14. The transport climate control system of claim 11, wherein the controller is further configured to, upon the temperature within the climate controlled space reaching the cycle-off temperature, instruct a variable speed compressor of the transport climate control system to stop compressing working fluid, and
determine a reference cycle-off time based on an amount of time for the transport climate control system to reach a cycle-on temperature from the cycle-off temperature while the variable speed compressor has stopped compressing working fluid; and
upon the temperature within the climate controlled space reaching the cycle-on temperature, the controller is configured to:
instruct the variable speed compressor to compress working fluid,
operate the transport climate control system at a maximum climate capacity, and
determine a reference cycle-on time based on an amount of time for the transport climate control system to reach the cycle-off temperature from the cycle-on temperature while the variable speed compressor is compressing working fluid and the transport climate control system operating at the maximum climate capacity.

15. The transport climate control system of claim 11, wherein the controller is further configured to determine at least one of a scaled cycle-on time, a scaled cycle-off time, and a scaled capacity based on the scaled duty cycle.

16. The transport climate control system of claim 11, wherein the controller is further configured to determine a temperature trajectory of the scaled duty cycle and determine a scaled cycle on-time, a scaled cycle-off time, and a scaled climate capacity to minimize a temperature difference between the cycle-off temperature and a desired temperature setpoint within the climate controlled space.

17. The transport climate control system of claim 16, wherein the controller is further configured to:
operate the transport climate control system to reach a cycle-on temperature and the cycle-off temperature based on the scaled duty cycle; and
update the scaled cycle on-time and the scaled cycle-off time based on the updated scaled duty cycle for a following cycle of the controller operating the transport climate control system from the cycle-on temperature to the cycle-off temperature.

18. The transport climate control system of claim 11, wherein the controller is further configured to determine the scaled duty cycle to be less than a maximum lifespan cycling frequency predetermined for prolonging a lifespan of the transport climate control system.

19. The transport climate control system of claim 11, wherein the controller is further configured to determine the scaled duty cycle to be less than a maximum noise cycling frequency predetermined for controlling noise in the transport climate control system.

20. The transport climate control system of claim 11, wherein the controller is further configured to determine the cycle-off temperature and a cycle-on temperature based on one or more predetermined offset temperatures from a desired temperature setpoint within the climate controlled space.
